(19) United States
(12) Patent Application Publication
(10) Pub. No.: US 2004/0217757 A1
(43) Pub. Date: Nov. 4, 2004

(54) Linear position sensor

(76) Inventor: Gerald A. Tromblee, Hanover, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/381,969

(22) PCT Filed: Sep. 28, 2001
(86) PCT No.: PCT/US01/30333

Related U.S. Application Data
(60) Provisional application No. 60/237,346, filed on Sep. 29, 2000.

(51) Int. Cl. G01B 7/30

(52) U.S. Cl. 324/207.2; 324/207.21; 324/207.25

(57) ABSTRACT

A position sensor (5) including a moveable agent (14) and a magnetic sensor (15) for detecting the change in magnetic induction caused by displacement of the magnet. The magnet is oriented relative to the path of displacement such that the magnet moves angularly relative to the magnetic sensor.

### CROSS REFERENCE TO RELATED APPLICATIONS

The present application claims priority to U.S. provisional application serial No. 60/237,346, the teachings of which are incorporated herein by reference.

### FIELD OF THE INVENTION

The present invention relates generally to linear position sensors.

### BACKGROUND OF THE INVENTION

In a wide variety of applications it is necessary and advantageous to sense the linear position of a translating element. For example, in automotive seat applications the seat translates fore and aft on associated track assemblies, either manually or automatically via electro-mechanical means. It is advantageous in automotive application to sense the linear position of the seat on the rack For example, the linear position may be used in a mechanism for controlling deployment of an air bag. Also, the sensed position maybe used for controlling the electro-mechanical actuator that causes translation of the seat, e.g. to provide a seat position memory feature. To date, however, there remains a need for a linear position sensor that is efficient, accurate, and cost-effective. Accordingly, there is a need in the art for a linear position sensor that obviates the deficiencies of the prior art.

### BRIEF DESCRIPTION OF THE DRAWINGS

Exemplary embodiments of the invention are set forth in the following description and shown in the drawings.

FIGS. 1 through 4 are top, isometric, side and end views, respectively, of an exemplary linear position sensor consistent with the invention;

FIGS. 5 through 8 are top, isometric, side, and end views, respectively, of another exemplary linear position sensor consistent with the invention;

FIG. 9 is a plot of magnet position vs. sensed field strength, for three exemplary configurations consistent with the invention;

FIG. 10 is an isometric view of another exemplary linear position sensor consistent with the invention, in a cylindrical configuration;

FIG. 11 is an isometric view of another exemplary linear position sensor consistent with the invention, in a rotary configuration;

FIG. 12 and 13 is a side view of a variation on the exemplary linear position sensor shown in FIG. 11;

FIG. 14 and 15 illustrate top view of two exemplary linear position sensors suitable for application to a rotating disk; and

FIG. 16 is an end view of another exemplary linear position sensor consistent with the invention.

### DETAILED DESCRIPTION

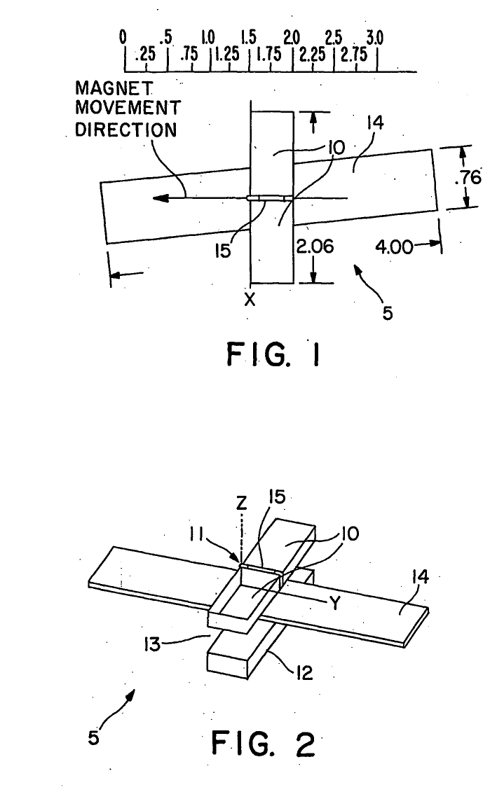

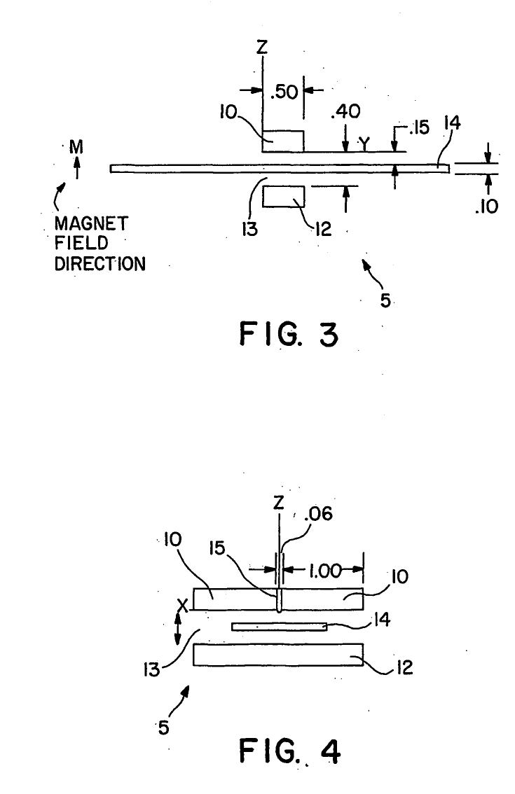

Referring to FIGS. 1 through 4, an exemplary linear position sensor consistent with the invention will be described in connection with a Hall effect sensor. Those skilled in the art will recognize, however, that a variety of sensing means may be used. For example, optical, magneto-resistive, fluxgate sensors, etc. may be useful in connection with a sensor consistent with the invention.

In FIGS. 1 through 4, there is shown an exemplary linear position sensor 5 consistent with the invention. As shown, the position sensor 5 includes two stators 10 delimiting an air gap 11 within which a Hall effect sensor 15 is disposed. A yoke 12 is disposed beneath the stators 10, as shown, so as to define an air gap 13 therebetween, within which a magnet 14 may travel. The magnet 14 is oriented such that, along the x- and y-axes, none of its edges are parallel or perpendicular to the stators 10 or the yoke 12. The magnet 14 is disposed within the air gap 13 such that the linear travel path of the magnet 14 is parallel to the length of the principal air gap 11 and the sensor 15, along the y-axis. Thus, as the magnet 14 travels on its linear path along the y-axis, the sensor 15 detects the change in magnetic induction caused by the linear displacement of the magnet 14 along the x-axis. When the magnet is secured to a moving part e.g. an automotive seat track, the position of the seat track, and hence the seat, is directly proportional to the output of the sensor.

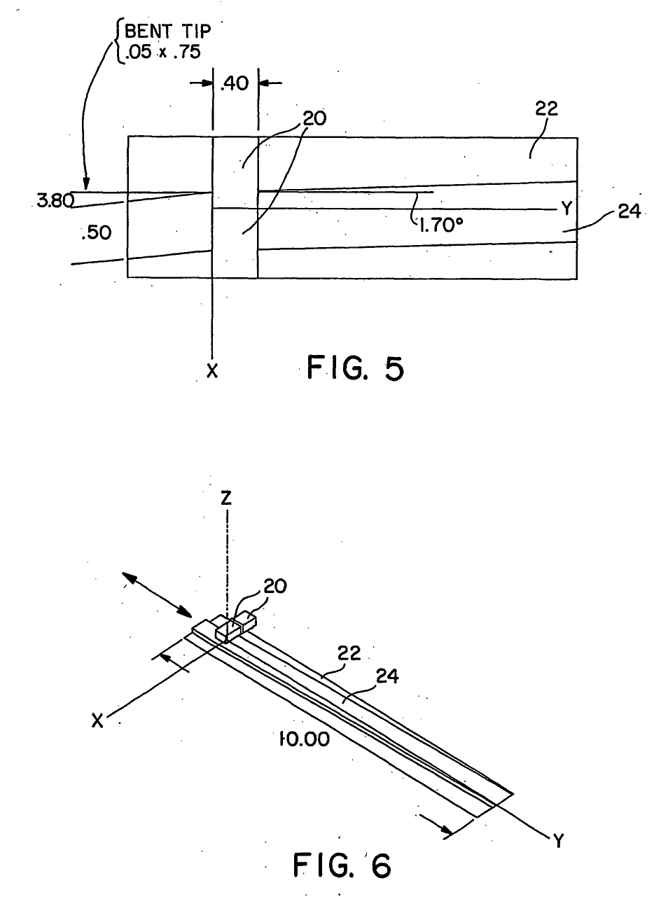

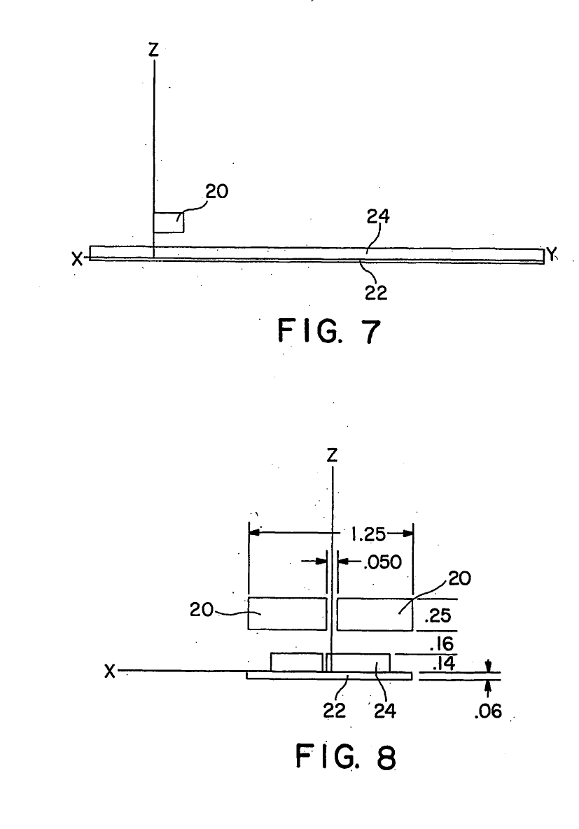

FIGS. 5 through 8 illustrate another exemplary linear position sensor consistent with the invention. In this embodiment, the operation and configuration of the linear position sensor is similar to that shown in FIGS. 1 through 4 and described above, with the exception that the yoke 22 and the magnet 24 move in tandem, instead of the yoke 22 being fixed with respect to the stators 20. Also, the forward end of the magnet is positioned at an angle relative to the remainder of the magnet, as shown for example in FIG. 5.

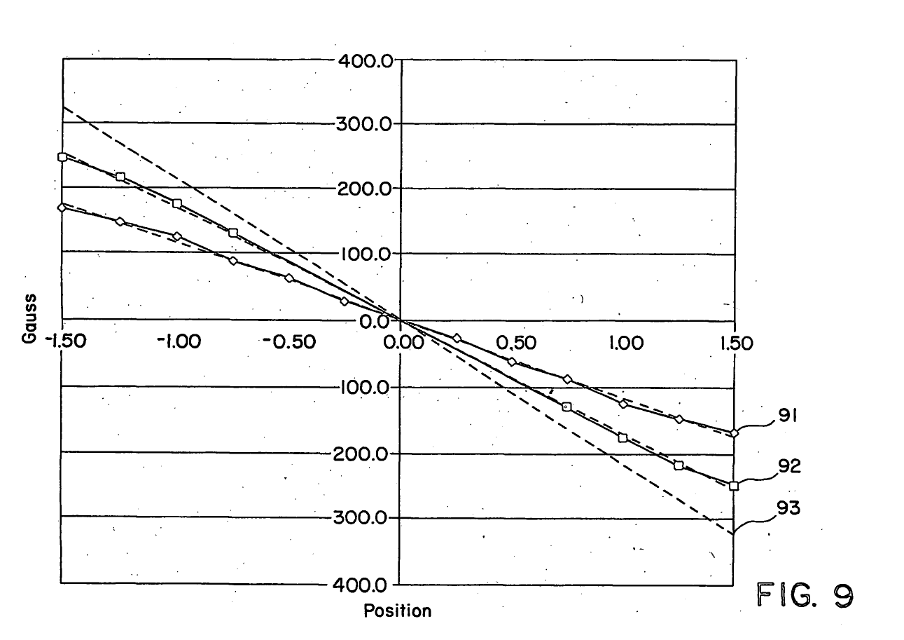

FIG. 9 is a plot of magnet position vs. sensor output in Gauss, illustrating the relationship between magnetic induction and the position of the magnet with respect to the sensor, at various positions, for three exemplary configurations. In the first and second configurations, curves 91 and 92 show the magnetic induction measurements for the exemplary linear position sensor illustrated in FIGS. 1 through 4 and described above, with a 0.40 and 0.25 air gap, respectively. In the third configuration, curve 93 shows the magnetic induction measurements for the exemplary linear position sensor illustrated in FIGS. 5 through 8 and described above, wherein the magnet and the yoke move in tandem Advantageously, each curve is substantially linear, thereby allowing position sensing based on the sensor output

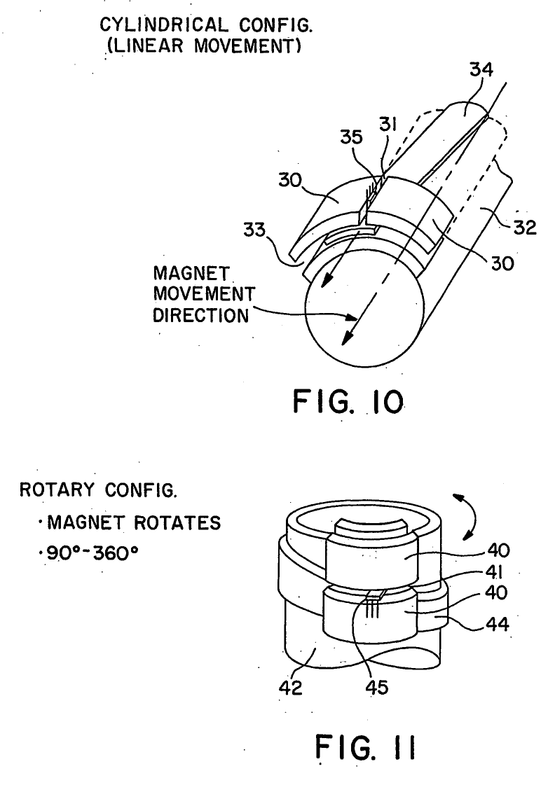

FIG. 10 illustrates another exemplary linear position sensor consistent with the invention, in a cylindrical configuration As shown, a pair of arcuate stators 30 define an air gap 31 therebetween, within which a Hall effect sensor 35 is disposed. The yoke 32 is cylindrical and is disposed so as to permit its linear travel parallel to the length of the air gap 31, and so as to define an air gap 33 between the yoke 32 and the stators 30. The magnet 34 is attached to the yoke 32 such that the magnet 34 and the yoke 32 move in tandem. The magnet 34 is oriented such that none of the edges of the magnet 34 are parallel or perpendicular to the direction of travel of the cylindrical yoke 32, or to the stators 30. Thus, as the magnet 34 travels on its linear path in tandem with the yoke 32, the sensor 35 detects the change in magnetic induction caused by the displacement of the magnet 14 along an arc defined by the arcuate edges of the stators 30.

FIG. 11 illustrates another exemplary linear position sensor consistent with the invention, in a rotary configuration. As shown, a pair of arcuate stators 40 define an air gap 41 therebetween, within which a Hall effect sensor. 45 is disposed. The yoke 42 is cylindrical and is disposed so as to permit its rotation about its axis. Another air gap is defined by the area between the cylindrical yoke 42 and the stators 40. An elongate spiral magnet is disposed around the cylindrical yoke 42 such that the magnet 44 and the yoke 42 move in tandem. Thus, as the yoke 42 rotates in tandem with the magnet 44, the 4. sensor 45 detects the change in magnetic induction caused by the linear displacement of the magnet 44 in a direction parallel to the axis of rotation of the yoke 42.

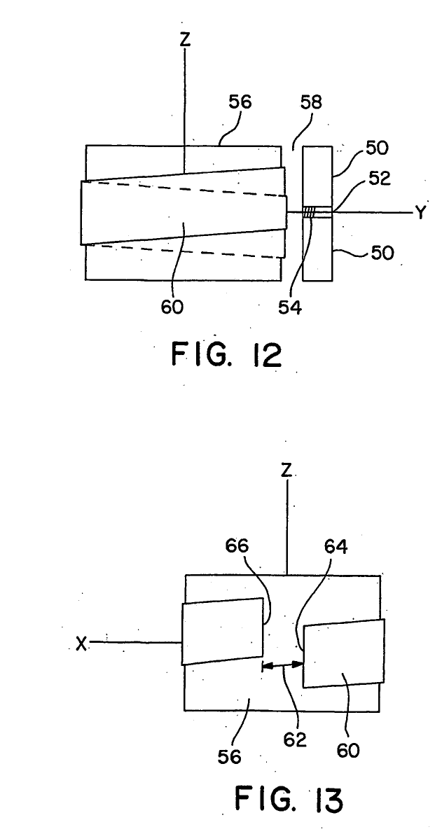

FIGS. 12 and 13 depict a variation on the exemplary linear position sensor shown in FIG. 11. As shown in FIGS. 12 and 13, a pair of arcuate stators 50 define an air gap 52 having a Hall effect sensor 54 disposed therein. Also similar to the embodiment illustrated in FIG. 11, a cylindrical yoke 56, capable of rotating about its axis, is spaced apart from the stators 50 defining another air gap 58 therebetween. Disposed about the circumference of the yoke 56 is an elongated magnet 60 capable of moving in tandem with the yoke 56. However, in contrast to the embodiment illustrated in FIG. 11, the magnet 60 of the present embodiment is discontinuous, such that there exists a circumferential space 62 between the first end 64 and the second end 66 of the magnet 60. As with the previous embodiment, as the yoke 56 rotates in tandem with the magnet 60, the Hall effect sensor 54 detects the change in magnetic induction caused by the linear displacement of the magnet 60 in a direction parallel to the axis of rotation of the yoke 56. Consistent with this embodiment, a linear output can be obtained for rotational angles of up to about 300 degrees. As with the embodiment illustrated in FIG. 11, the instant embodiment consistent with the present invention may be configured such that the magnet, stators, and Hall effect sensor are disposed within the interior of a tubular yoke.

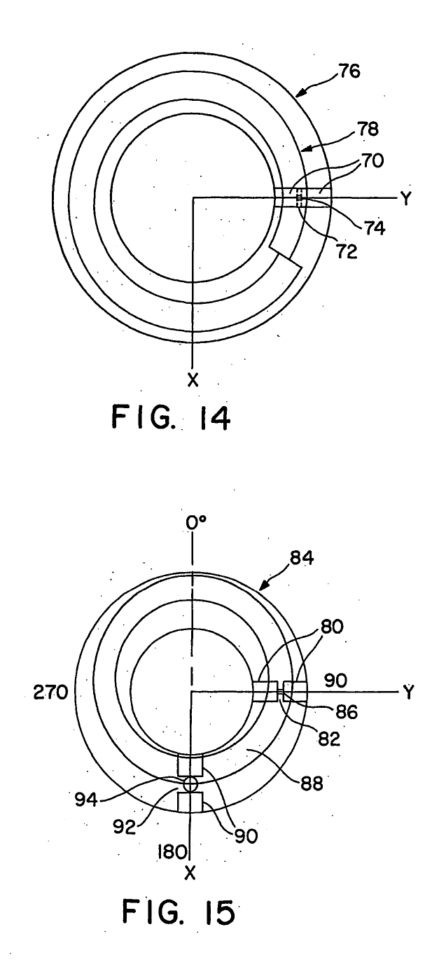

Referring to FIGS. 14 and 15 there is shown two exemplary linear positions sensors consistent with the present invention. Referring first to FIG. 14, the position sensor includes two spaced apart stators 70 having and air gap 72 therebetween. Disposed within the air gap 72 is a Hall effect sensor 74. The two stators 70 and the Hall effect sensor 74 are disposed above a surface of a disk shaped yoke 76 separated by an air gap. Disposed upon the surface of the yoke 76 is an elongated magnet 78 configured in the shape of a spiral. Accordingly, when the yoke 76 and magnet rotate in tandem about the axis of the yoke the Hall effect sensor 74 detects the change in magnetic induction caused by the linear displacement of the magnet 78 in a direction radial to the axis of rotation of the yoke 76.

The exemplary embodiment illustrated in FIG. 15 operates in a similar manner as the embodiment shown in FIG. 14. As illustrated, two stators 80 having an air gap 82 are disposed above a disk shaped yoke 84. Disposed in the air gap 82 between the two stators 80 is a Hall effect sensor 86. Disposed between the yoke 84 and the stators 80 is a magnet 88 in the shape of a ring. The magnet 88 is positioned eccentrically relative to the yoke 84, i.e., the axis of the magnet 88 is not collinear with the axis of the yoke 84. Accordingly, as the yoke 84 and magnet 88 rotate in tandem about the yoke's axis the Hall effect sensor 86 detects the change in magnetic induction caused by the radial displacement of the magnet 88 relative to the axis of the yoke 84.

Further to the exemplary embodiment illustrated in FIG. 15, if the magnet 88 is properly shaped and positioned relative to the axis of the yoke 84 the output from the Hall effect sensor will be a sine wave. The displacement may be calculated from the sine wave output. Alternately, the position sensor may include a second pair of stators 90 offset 90 degrees around the yoke 84 from the first pair of stators 80. As with the first pair of stators 80, the second pair of stators are spaced apart having an air gap 92 therebetween. Situated in the air gap 92 is a second Hall effect sensor 94. The second pair of stators 90 will similarly produce a sine wave output resulting from the displacement of magnet 88 as it rotates in tandem with the yoke 84. The arc tangent of the sine wave outputs of the two Hall effect sensors 86 and 94 will provide a linear output over the full 360 degree rotation of the yoke 84.

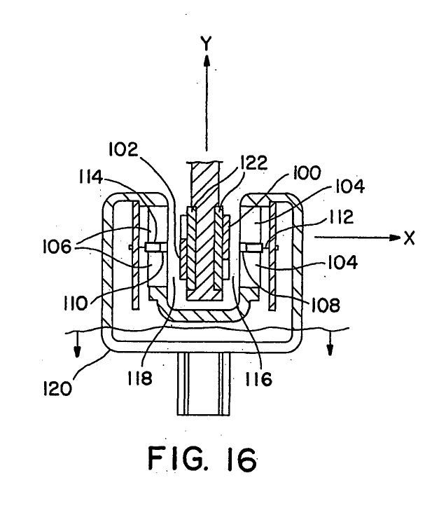

In a final illustrated exemplary embodiment shown in FIG. 16 two magnets 100 and 102 employed rendering the sensor insensitive to movement in the Y direction. The magnets 100 and 102 are angled oppositely relative to each other along the length of the magnet in the Z direction, in and out of the page as illustrated. Corresponding to each of the magnets 100 and 102 is a pair of stators 104 and 106 respectively. As with previous embodiments, each pair of stators 104 and 106 is separated by an air gap, 108 and 110 respectively. In each of the air gaps 108 and 110 is a Hall effect sensor 112 and 114. Also, as with previous embodiments both of the two pairs of stators 104 and 106 are spaced from the magnets 100 and 102 by respective air gap 116 and 118.

As illustrated, the stator/Hall effect sensor assemblies are disposed on either side of U shaped channel 120 such that each assembly is facing the other. The magnets and accompanying stators 122 are disposed between the two stator/Hall effect sensor assemblies. Accordingly, as the magnets are translated along the Z direction each of the Hall effect sensors 104 and 106 detects the change in magnetic induction caused by the linear displacement of the respective magnets 100 and 102 in the Y direction. By averaging the outputs of the two sensors 104 and 106 the position sensor is rendered insensitive to movement in the Y direction. Additionally, while not render completely insensitive to movement in the X direction, such sensitivity is reduced.

The exemplary embodiment consistent with the present invention as illustrated in FIG. 16, and described with reference thereto, may also be configured such that the two stator/Hall effect sensor assemblies are disposed adjacent to each other such that the sensing face of the two assemblies are oppositely directed. Accordingly, the two magnets 100 and 100 would be disposed on the interior of the U channel. Similarly, the two magnets 100 and 102 may be positioned side by side, therein eliminating the need for the U channel arrangement Furthermore, it should be appreciated that the principles described in conjunction to this exemplary embodiment may be applied to any of the preceding exemplary embodiments to realize the same advantages.

The embodiment described herein have applicability beyond the scope of seat position sensing. These systems could apply to sensing the linear position of any translating element. The embodiments that have been described herein are, therefore, but some of the several which utilize this invention and are set forth here by way of illustration but not of limitation. It is obvious that many other embodiments, which will be readily apparent to those skilled in the art may be made without departing materially from the spirit and scope of the invention as defined in the appended claims.

What is claimed is:

1. A position sensor comprising:
a magnetic sensor; and
a magnet disposed on a movable element for angular motion of the magnet relative to said magnetic sensor.

2. The position sensor according to claim 1 wherein said magnetic sensor is a Hall effect sensor.

3. The position sensor according to claim 1 wherein said moveable element is a rotatable element.

4. The position sensor according to claim 1 wherein said moveable element is translatable.

5. The position sensor according to claim 4 wherein said magnet is a longitudinal member having a longitudinal axis, the longitudinal axis being angled from direction of translation.

6. The position sensor according to claim 2 wherein said Hall effect sensor further comprises a stator disposed adjacent to said Hall effect sensor.

7. A position sensor comprising:
two spaced apart stators having a Hall effect sensor disposed in the space therebetween; and
a magnet having a longitudinal axis, the magnet translatable along a linear axis, wherein the longitudinal axis of the magnet is angularly displaced from the linear axis.

8. A position sensor comprising:
two spaced apart arcuate stators having a Hall effect sensor disposed in the space therebetween; and
a helical magnet rotatable about a central axis, whereby rotation of the helical magnet about the central axis provides angular movement of the magnet relative to the Hall effect sensor.

9. A position sensor comprising:
two spaced apart stators having a Hall effect sensor disposed in the space between the two stators; and
a spirally configured magnet rotatable about a central axis.

10. A position sensor comprising:
a ring shaped magnet eccentrically rotatable in a plane normal to the axis of the ring shaped magnet;
two spaced apart stators disposed above the ring shaped magnet; and
a Hall effect sensor disposed in the space between the two stators.
